(19) United States
(12) Patent Application Publication
(10) Pub. No.: US 2008/0316010 A1
(43) Pub. Date: Dec. 25, 2008

(54) RECORDING SYSTEM AND METHOD FOR CAPTURING IMAGES OF DRIVING CONDITIONS AND DRIVING IMAGES IDENTIFICATION METHOD

(75) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: APPRO TECHNOLOGY INC., Taipei County (TW)

(21) Appl. No.: 11/767,482

(22) Filed: Jun. 23, 2007

(51) Int. Cl. B60Q 1/00

(52) U.S. Cl. 340/439

(57) ABSTRACT

A recording system for capturing images of driving conditions of a vehicle is provided. The vehicle has a plurality of sensors and an instrument panel for displaying situations of the sensors. The recording system includes at least a first camera module disposed in front of the instrument panel for capturing an image of the instrument panel to generate a first image data. Since the driving conditions are captured in the form of an image, the driving conditions can be easily understood by reading the first image data. A recording method for capturing images of the driving conditions of the vehicle is also disclosed. Furthermore, a driving image identification method for identifying the driving conditions is also disclosed.

### BACKGROUND OF THE INVENTION

1. Field of the Invention

The present invention relates to a tachographic system. More particularly, the present invention relates to a recording system and method for capturing images of driving conditions and driving image identification method.

2. Description of Related Art

Traffic accidents are mainly caused due to negligent driving or violation of traffic rules by a driver. However, if the police determine the cause of an accident and judge the responsibility only according to the situation or evidence available at the accident site, human misjudgement is inevitable.

With the development of technologies, some of the vehicles are equipped with the tachographic system for recording the driving information such as the driving speed and the applications of the brake, steering wheel and light signals. Therefore, the police may infer the driving conditions at the time an accident occurs from the driving information recorded by the tachographic system.

A conventional mechanical tachographic system uses a mechanical shaft driven pointer to draw a speed curve, which has a low accuracy, and only a professional can interpret it. Therefore, it has the disadvantage of a lengthy processing time and may be susceptible to tampering. Compared to the conventional mechanical tachographic system, a digital tachographic system not only has the advantage of convenience in data transmission and management, but also has many other advantages such as the reduction of human misjudgement, expandability, ease of integration, and recording of different data combinations according to different requirements.

However, since the tachographic system records driving information in digital format, the interpretation of digital data is relatively difficult. Moreover, since the tachographic system does not record the actual images of internal and external environments, human misjudgement may still occur when the aforementioned recorded data of driving conditions is relied upon.

### SUMMARY OF THE INVENTION

The present invention is directed to a recording system for capturing images of driving conditions, which is configured to capture the driving conditions in the form of images for easily interpreting the driving information.

The present invention is directed to a recording method for capturing images of driving conditions which is configured to capture the driving conditions in the form of images for easily interpreting the driving conditions.

The present invention is directed to a driving image identification method for identifying driving conditions according to the images captured by cameras.

The present invention provides a recording system for capturing images of driving conditions of a vehicle. The vehicle includes a plurality of sensors and an instrunent panel for displaying situations of the sensors. The recording system includes at least a first camera module disposed in front of the instrument panel for capturing an image of the instrument panel to generate a first image data.

In an embodiment of the present invention, the aforementioned first camera module transmits the first image data via cable or wireless transmission mode.

In an embodiment of the present invention, the aforementioned recording system further comprises a storage unit disposed inside the first camera module or in the vehicle for storing the first image data.

In an embodiment of the present invention, the aforementioned recording system further comprises a first processing unit disposed inside the first camera module or in the vehicle for storing the first image data into the storage unit and/or reading the first image data in the storage unit.

In an embodiment of the present invention, the aforementioned recording system further comprises a second camera module disposed inside the vehicle for capturing an image outside the vehicle to generate a second image data.

In an embodiment of the present invention, the aforementioned recording system further comprises a storage unit disposed inside the second camera module or in the vehicle for storing the second image data.

In an embodiment of the present invention, the aforementioned recording system further comprises a second processing unit disposed inside the second camera module or in the vehicle for storing the second image data into the storage unit and/or reading the second image data in the storage unit.

In an embodiment of the present invention, the aforementioned recording system further comprises an image combination unit for combining the first image data with the second image data.

The present invention further provides a recording method for capturing images of driving conditions of a vehicle. The vehicle includes a plurality of sensors and an instrument panel for displaying situations of the sensors. The recording method includes disposing at least a first camera module in front of the instrument panel for capturing an image of the instrument panel to generate a first image data.

In an embodiment of the present invention, the aforementioned recording method further includes disposing at least a second camera module in the vehicle for capturing an image outside the vehicle to generate a second image data.

In an embodiment of the present invention, the aforementioned recording method further includes synchronously reading the first image data and the second image data, and combining the first image data and the second image data to generate an output data.

In an embodiment of the present invention, the aforementioned recording method further includes decoding the combined output data to generate separately the first image data and the second image data.

The present invention further provides a driving image identification method for identifying driving conditions of a vehicle. The vehicle includes a plurality of sensors and an instrument panel for displaying the situations of the sensors. The identification method includes disposing at least a first camera module in front of the instrument panel for capturing a plurality of images of the instrument panel at different time points to generate the corresponding plurality of the first image data. The plurality of the first image data captured by the first camera module at different time points may be identified for judging the variations in the states of the sensors on the instrument panel to generate the readable data of the driving conditions.

In an embodiment of the present invention, the aforementioned identification method further includes outputting a notification signal when the variations in the states of the sensors displayed on the instrument panel complies with a preset reference standard.

In an embodiment of the present invention, according to the aforementioned identification method, the variations in the states of the sensors includes the variations of the pointers on the instrument panel, the variations of the indicators on the instrument panel and the variations of the digits on the electronic display panel.

In an embodiment of the present invention, the aforementioned identification method further includes disposing at least a second camera module in the vehicle for capturing an image outside the vehicle to generate a second image data.

In an embodiment of the present invention, the aforementioned identification method further includes synchronously reading the first image data and the second image data, and combining the first image data and the second image data to generate an output data.

Since the present invention employs the first camera module to record the driving conditions to generate the first image data, the driving conditions can be easily understood by reading the first image data, so that the possibility of human misjudgement may be effectively reduced.

In order to make the aforementioned and other aspects, features and advantages of the present invention comprehensible, preferred embodiments accompanied with figures are described in detail below.

### BRIEF DESCRIPTION OF THE DRAWINGS

FIG. 1 is a schematic diagram of a recording system disposed in a vehicle according to a first embodiment of the present invention.

FIG. 2 is a schematic diagram of driving conditions displayed on the instrument panel of the vehicle as shown in FIG. 1.

FIG. 3 is a block diagram illustrating the recording system recording the driving conditions of the vehicle as shown in FIG. 1 according to the first embodiment of the present invention.

FIG. 4 is a schematic diagram of a recording system disposed in a vehicle according to a second embodiment of the present invention.

FIG. 5 is a block diagram illustrating the recording system recording the driving conditions of the vehicle as shown in FIG. 1 according to the second embodiment of the present invention.

### DESCRIPTION OF EMBODIMENTS

### The First Embodiment

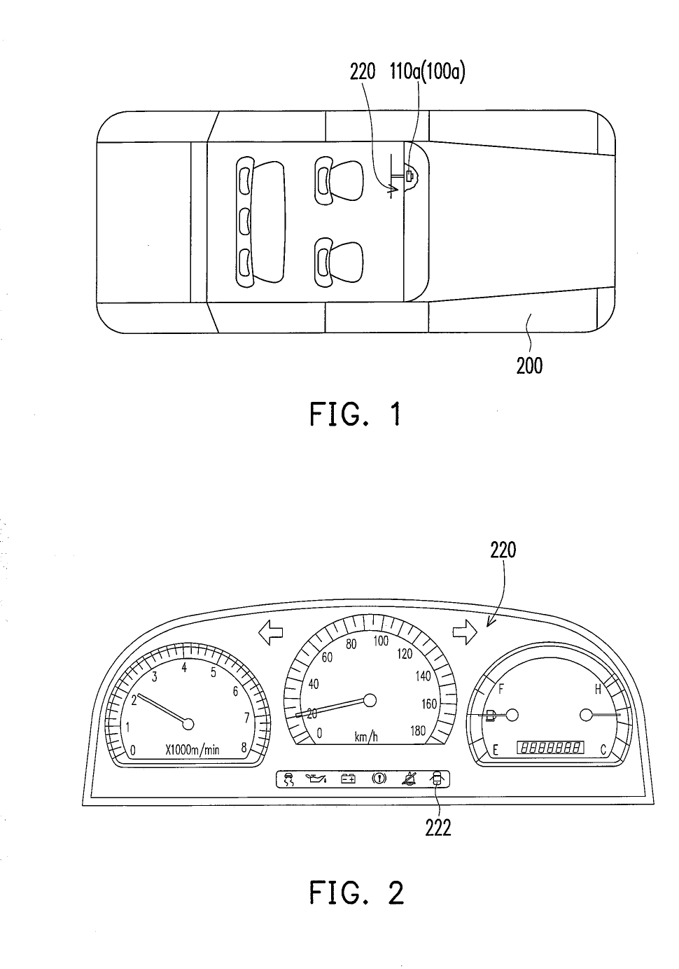

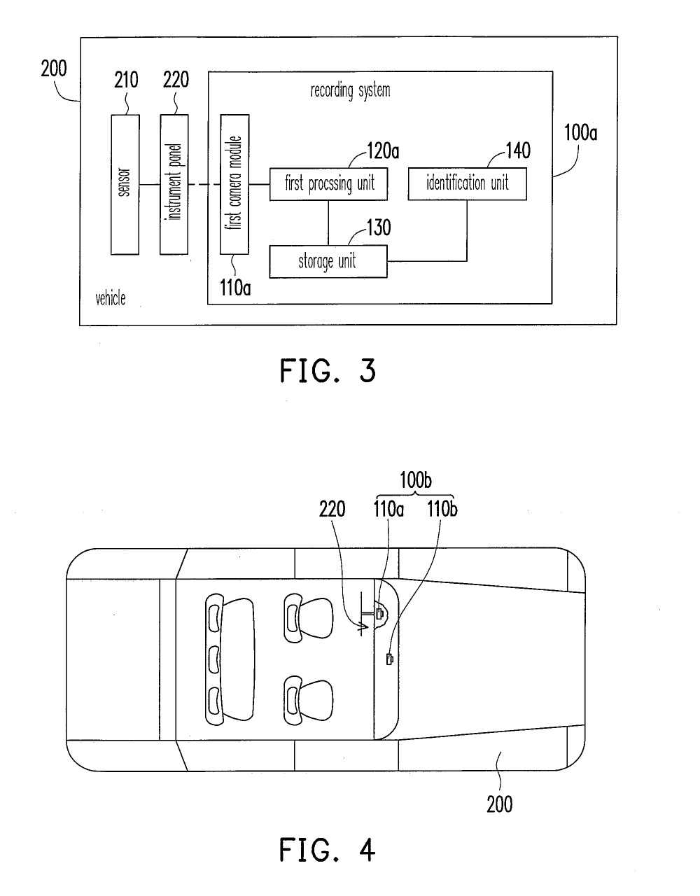

FIG. 1 is a schematic diagram of a recording system disposed in a vehicle according to a first embodiment of the present invention. FIG. 2 is a schematic diagram of driving conditions displayed on the instrument panel of the vehicle as shown in FIG. 1. FIG. 3 is a block diagram illustrating the recording system recording the driving conditions of the vehicle as shown in FIG. 1 according to the first embodiment of the present invention. Referring to FIG. 1 to FIG. 3, the recording system 100a is installed inside a vehicle 200 for capturing images of the driving conditions of the vehicle 200. In the present embodiment, the vehicle 200 may be a car, an airplane or a ship, and the driving conditions may include, for example, the vehicle speed, engine speed, fuel quantity, the quantity of water in the water tank, the brake indicator, engine indicator, battery indicator, engine oil indicator, door state indicator, headlight indicator, and the turning indicator.

The vehicle 200 has a plurality of sensors 210 and an instrument panel 220. The sensors 210 are used for sensing the aforementioned driving conditions and transmitting the sensing results to the indicators and meters on the instrument panel 220 to display the state of the sensors 210. The recording system 100a includes at least a first camera module 110a disposed in front of the instrument panel 220 for capturing an image of the instrument panel 220 indicating the state of the sensors 210 to generate a first image data.

In the present embodiment, the recording system 100a further comprises a first processing unit 120a and a storage unit 130. The first processing unit 120a and the storage unit 130 are, for example, respectively disposed at a suitable position inside the vehicle 200 (or integrated with the first camera module 110a), and the storage unit 130 may electrically connect to the first camera module 110a via the first processing unit 120a, wherein the first processing unit 120a controls the accessing of the first image data, and the storage unit 130 is used for storing the first image data.

More specifically, after the first camera module 110a captures the image of the instrument panel 220 to generate the first image data, the first processing unit 120a controls the storage unit 130 to store the first image data in the storage unit 130. Afterwards, the first image data stored in the storage unit 130 can be read by the first processing unit 120a to restore the driving conditions recorded at the time an accident occurred.

Since the recording system 100a of the present invention captures the image of the instrument panel 220 to generate a first image data, and the first image data is stored in the storage unit 130, therefore, the driving conditions can be learnt by reading the first image data, and therefore the possibility of human misjudgement as in the case of the conventional technique can be effectively reduced.

However, the first processing unit 120a and the storage unit 130 are not limited to be disposed in the recording system 100a, they may also be disposed in the vehicle 200. For example, the first processing unit 120a and the storage unit 130 can be allocated in the engine control unit (ECN) of the vehicle 200. In this case, the first processing unit 120a may be electrically connected to the first camera module 110a via a cable for exchanging the first image data with the first camera module 110a, or the first camera module 110a may have a wireless signal transmitter, and the first processing unit 120a may have a corresponding wireless signal receiver for exchanging the first image data with the first camera module 110a through a wireless signal. Moreover, the first processing unit 120a and the storage unit 130 may further be integrated into the system on chip (SOC) of the first camera module 110a.

In addition, the recording system 100a is not limited for use in cars, it may also be used in various types of vehicles. Moreover, the recording system 100a may include a plurality of first camera modules 110a if the instrument panel 220 has a larger size, and the first camera modules 110a may respectively capture images of the instrument panel 220 to generate a plurality of first sub-image data. In this case, these first sub-image data may further be combined to generate the first image data through the first processing unit 120a, and the first image data may be stored in the storage unit 130.

Moreover, in the identification method, the recording system 100a further includes an identification unit 140. The identification unit 140 may be electrically connected to the storage unit 130 through the first processing unit 120a, or directly connected to the storage unit 130 for identifying a plurality of first image data captured by the first camera module 110a at different time points, so as to judge the variations in the states of the sensors 210 on the instrument panel 220 to generate readable data of the driving conditions. In addition, when the variations in the states of the sensors on the instrument panel 220 complies with a preset reference standard, the recording system 100a outputs a notification signal to notify the driver.

For example, the reference standard can be preset as follows: if the door state indicator 222 on the instrument panel 220 lights up after the vehicle is started, the driver is notified accordingly. When the vehicle 200 is started, the first camera module 110a captures an image, and stores the image data in the storage unit 130 through the first processing unit 120a. Then, the identification unit 140 reads the image data stored in the storage unit 130 for identification.

Here, the identification unit 140 identifies whether the indicator 222 lights up to judge whether a door is closed. If the door is open, the indicator 222 lights up (identical with the preset reference standard), and the identification unit 140 may notify the driver to close the door by sending a warning signal; meanwhile, the identification unit 140 keeps identifying an image data captured at the next time point. When the door is closed, the identification unit 140 identifies the indicator 222 is turned off (different from the preset reference standard) and stops sending the warning signals, or the identification unit 140 may stop sending the warning signals by identifying the present state of the indicator 222 (turned off) is different from the state of the indicator 222 (lit up) at the previous time point.

In addition, the variation in the states of the sensors 210 includes the variations of pointers on the instrument panel 220 such as vehicle speed, engine speed, fuel quantity, the quantity of water in the water tank, and variations of indicators on the instrument panel 220 such as the brake indicator, engine indicator, battery indicator, engine oil indicator, door state indicator, headlight indicator, and the turning indicator. Furthermore, the variation in the states of the sensors 210 may further comprise variations of digits on the electronic display panel such as vehicle speed and engine speed.

### The Second Embodiment

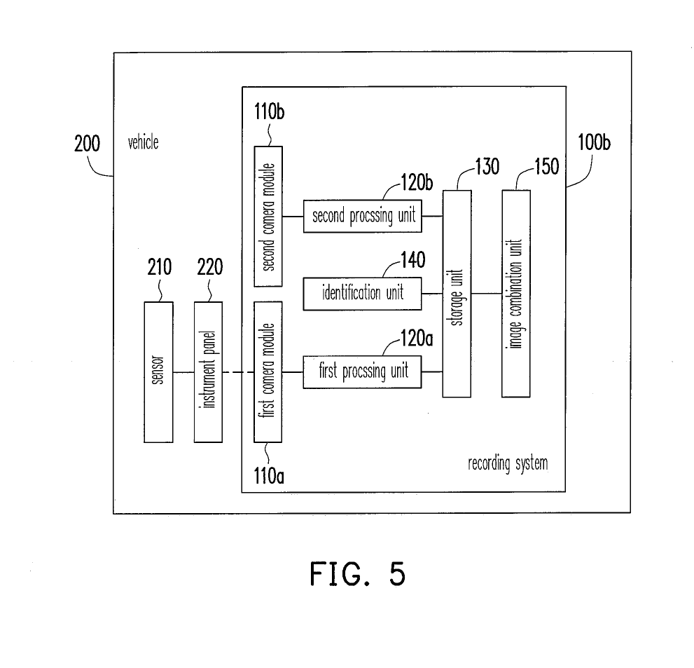

FIG. 4 is a schematic diagram of a recording system disposed in a vehicle according to a second embodiment of the present invention. FIG. 5 is a block diagram illustrating the recording system recording the driving conditions of the vehicle as shown in FIG. 1 according to the second embodiment of the present invention. Referring to FIG. 4 and FIG. 5, compared to the recording system 100a of the first embodiment, the recording system 100b of the second embodiment further comprises at least a second camera module 110b and a second processing unit 120b. The second camera module 110b is disposed in the vehicle 200 for capturing an image outside the vehicle 200 to generate a second image data.

In the second embodiment, the second camera module 110b may be placed on the rear-view mirror above the instrument panel 220 for capturing an image in front of and/or behind the vehicle 200. The second processing unit 120b may be placed at a suitable position (or integrated with the second camera module 110b) inside the vehicle 200. The storage unit 130 may be electrically connected to the second camera module 110b through the second processing unit 120b. The first processing unit 120a and the second processing unit 120b respectively control the accessing of the first image data and the second image data. The storage unit 130 is used for storing the first image data and the second image data.

More specifically, after the second camera module 110b captures the image outside the vehicle 200 to generate the second image data, the second processing unit 120b controls the storage unit 130 to store the second image data in the storage unit 130. The second image data stored in the storage unit 130 can be read by the second processing unit 120b later to restore the conditions in front of the vehicle 200 recorded at the time when an accident occurs. Moreover, the accessing method of the first image data is the same as that of the first image data in the first embodiment, and therefore the description thereof will not be repeated.

Since the recording system 100b is installed inside the vehicle 200, and the first image data and the second image data are stored in the storage unit 130, therefore, when an accident occurs, the driving conditions and the actual conditions in front of and/or behind the vehicle 200 can be recorded and stored so that the actual conditions of the accident may be learnt by reading the first and the second image data, and therefore the possibility of human misjudgement may be effectively reduced.

In addition, the recording system 100b may further comprise an identification unit 140 electrically connected to the storage unit 130 for judging the states of the sensors 210 by identifying a plurality of first image data captured by the first camera module 110a at different time points. Or the identification unit 140 can also be used for judging the states outside the vehicle 200 by identifying a plurality of second image data captured by the second camera module 110b at different time points. Moreover, when the states of the sensors 210 and the states outside the vehicle 200 comply with a preset reference standard, the recording system 100b outputs a notification signal to notify the driver.

For example, the reference standard can be preset as: keeping at least a safe distance from the vehicle ahead. When the identification unit 140 judges the distance between the vehicle 200 and the vehicle ahead is less than the safe distance (identical to the preset reference standard) by identifying the second image data, the identification unit 140 may send a warning signal to notify the driver to keep a safe distance from the vehicle ahead; meanwhile, the identification unit 140 keeps identifying the second image data. When the identification unit 140 judges the distance between the vehicle 200 and the vehicle ahead is greater than the safe distance (different from the preset reference standard), the identification unit 140 stops sending the warning signal. Moreover, the process of the identification unit 140 identifying the first image data to judge the states of the sensors 210 is similar to the process described with reference to the first embodiment, and therefore the description thereof is not repeated.

In addition, the recording system 100b may further comprise an image combination unit 150 electrically connected to the storage unit 130. The first camera module 110a and the second camera module 110b respectively capture the first image data and the second image data. The first processing unit 120a and the second processing unit 120b respectively store the first image data and the second image data in the storage unit 130. Then, the image combination unit 150 combines the first image data and the second image data stored in the storage unit 130 to generate an output data. The output data can be stored in the storage unit 130 or shown on a vehicle display (not shown).

It should be noted that the time points of the first image data and the second image data must be confirmed to avoid human misjudgement due to the capture of the aforementioned data at different time points. Since the first image data and the second image data are combined to generate an output data, there is no different time point there between them, and therefore, when the driver or police restores the driving conditions and the actual conditions in front of the vehicle 200 recorded at the time when an accident occurred, there is no need to re-compare the time points there between them, and the possibility of human misjudgement can be further reduced.

In addition, in the second embodiment, the recording system 100b may comprise only one processing unit. In this case, the aforementioned processing unit controls both the accessing of the first image data and the second image data. Moreover, the recording system 100b may further comprise a plurality of second camera modules 110b for respectively capturing images of the conditions in front of, behind, on the left of, on the right of or on the other sides of the vehicle 200, such that the driver or police may have a full understanding of the actual conditions around the vehicle 200 when an accident occurred. Moreover, the recording system 100b may further decode the combined output data to generate separately the first image data and the second image data. In this case, a user may choose to separately read the first image data or the second image data.

In summary, since the present invention employs a first camera module to record the driving conditions to generate a first image data, the driving conditions can be easily understood by reading the first image data, and therefore, the possibility of human misjudgement can be effectively reduced. Moreover, since the present invention further employs a second camera module to record the conditions around the vehicle to generate a second image data, the driver or the police may have a full understanding of the actual conditions recorded around the vehicle 200 at the time the accident occurred by reading the second image data, and the responsibility for the accident can be easily clarified.

In addition, according to the present invention, the image combination unit may combine the first image data and the second image data to generate an output data, therefore when the driver or police restores the driving conditions and the actual conditions in front of the vehicle 200 recorded at the time when an accident occurred, there is no need to re-compare the time points there between them. Moreover, the identification unit may identify the first image data and the second image data so as to assist the driver to drive the vehicle more safely.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A recording system, suitable for capturing driving conditions of a vehicle, the vehicle having a plurality of sensors and an instrument panel for displaying situations of the sensors, the recording system comprising:
at least a first camera module, disposed in front of the instrument panel for capturing an image of the instrument panel to generate a first image data.

2. The recording system as claimed in claim 1, wherein the first camera module transmits the first image data via cable or wireless transmission mode.

3. The recording system as claimed in claim 1 further comprising a storage unit disposed inside the first camera module or in the vehicle for storing the first image data.

4. The recording system as claimed in claim 3 further comprising a first processing unit disposed inside the first camera module or in the vehicle for storing the first image data into the storage unit and or reading the first image data stored in the storage unit.

5. The recording system as claimed in claim 1 further comprising at least a second camera module disposed inside the vehicle for capturing an image outside the vehicle to generate a second image data.

6. The recording system as claimed in claim 5 further comprising a storage unit disposed inside the second camera module or in the vehicle for storing the second image data.

7. The recording system as claimed in claim 6 further comprising a second processing unit disposed inside the second camera module or in the vehicle for storing the second image data in the storage unit and/or reading the second image data stored in the storage unit.

8. The recording system as claimed in claim 5 further comprising an image combination unit for combining the first image data with the second image data.

9. A recording method for capturing images of driving conditions of a vehicle, the vehicle having a plurality of sensors and an instrument panel for displaying situations of the sensors, the recording method comprising:
disposing at least a first camera module in front of the instrument panel for capturing an image of the instrument panel to generate a first image data.

10. The recording method as claimed in claim 9 further comprising disposing at least a second camera module in the vehicle for capturing an image outside the vehicle to generate a second image data.

11. The recording method as claimed in claim 10 further comprising synchronously reading the first image data and the second image data, and combining the first image data and the second image data to generate an output data.

12. The recording method as claimed in claim 11 further comprising decoding the combined output data to generate separately the first image data and the second image data.

13. A driving image identification method for identifying driving conditions of a vehicle, the vehicle having a plurality of sensors and an instrument panel for displaying the situations of the sensors, the identification method comprising:
disposing at least a first camera module in front of the instrument panel for capturing a plurality of images of the instrument panel at different time points to generate the corresponding plurality of the first image data; and
identifying the plurality of the first image data captured by the first camera module at different time points for judging the variations in the states of the sensors on the instrument panel to generate the readable data of the driving conditions.

14. The identification method as claimed in claim 13 further comprising outputting a notification signal when the variations in the states of the sensors displayed on the instrument panel complies with a preset reference standard.

15. The identification method as claimed in claim 13, wherein the variations in the states of the sensors comprises the variations of the pointers on the instrument panel, the variations of the indicators on the instrument panel and the variations of the digits on the electronic display panel.

16. The identification method as claimed in claim 13 further comprising disposing at least a second camera module in the vehicle for capturing an image outside the vehicle to generate a second image data.

17. The identification method as claimed in claim 16 further comprising synchronously reading the first image data and the second image data, and combining the first image data and the second image data to generate an output data.
